(19) United States
(12) Patent Application Publication
(10) Pub. No.: US 2004/0145322 A1
(43) Pub. Date: Jul. 29, 2004

(54) Apparatus and method for simulating a pedal behavior

(76) Inventors: Ralf Trutschel, Ilmenau (DE); Klaus Augsburg, Amstadt (DE)

Correspondence Address: FORD GLOBAL TECHNOLOGIES, LLC., SUITE 600 - PARKLANE TOWERS EAST, ONE PARKLANE BLVD., DEARBORN, MI, 48126, US

(21) Appl. No.: 10/701,892

(22) Filed: Nov. 5, 2003

(30) Foreign Application Priority Data
Nov. 5, 2002 (EP) 02102535.8

(51) Int. Cl. H02P 1/00; H02P 7/00

(52) U.S. Cl. 318/139; 318/432; 318/434

(57) ABSTRACT

A device for simulating the force/position behavior of a motor vehicle pedal. In this case, the pedal position is adjusted by an electrohydraulic servo unit which is part of a control circuit. The guiding variable of the control circuit is the desired position of the pedal which is calculated from the pedal force using suitable algorithms. A force transducer is used to determine the pedal force, and interfering dynamic forces are eliminated by additionally taking the pedal acceleration into account.

### FIELD OF THE INVENTION

The present invention relates to motor vehicles control pedals, such as a brake or accelerator pedal, and more specifically to an apparatus for simulating a predetermined actuating behavior of the pedal in order to produce a desirable “pedal feel”. The invention furthermore relates to a method for simulating a predetermined actuating behavior of a pedal by adjusting the pedal position, the pedal position being detected by sensors.

### BACKGROUND OF THE INVENTION

The control functions of the pedals of a motor vehicle are increasingly carried out or supported by active actuating devices. One example of this is illustrated by electrohydraulically supported braking systems, in which the actual braking force is no longer produced by the pedal pressure, but rather by a hydraulic pressure reservoir. In order, however, to impart to the driver the customary pedal feel during the actuation of the pedal, it is known, for example from WO 00/68056, to connect the pedal to a “pedal feel simulator”. In said document, this is a hydraulically coupled piston which is under a spring force and, owing to a controllable valve, is coupled to the pedal or decoupled therefrom, as required.

### SUMMARY OF THE INVENTION

Against this background, it was an object of the present invention to provide the pedal feel simulator which can be used in general in motor vehicles and permits the simulation of a desired, predetermined pedal feel in a simple manner.

The apparatus according to the invention comprises an actuator with which the pedal can be move and a position sensor which permits the current pedal position to be measured. The pedal position can be measured, for example, as a distance or as an angle. The apparatus further comprises the following devices:

A force-determining unit which is designed to the effect that the pedal force can be determined. Pedal force is to be understood here as meaning the external force exerted on the pedal or the pedal plate by a user.

A desired position unit, the input of which is coupled to the force-determining unit and which is set up for the purpose of defining the desired position of the pedal corresponding to or associated with the particular pedal force in accordance with the desired actuating behavior. The actuating behavior of a pedal can be described mathematically by a force/position curve. A desired curve of this type is implemented in the desired position unit.

A regulator coupled on its input side to the desired position unit and the position sensor and coupled on its output side to the actuator, and designed to the effect that, in a feedback control circuit, the actual position of the pedal has to track the desired position predetermined by the desired position limit.

With the apparatus described, virtually any desired pedal feel can be realized on a pedal—such as, for example, the brake pedal or the accelerator pedal of a motor vehicle. For this purpose, the particular characteristic has merely to be implemented via its force/position curve in the desired position unit, the apparatus then, with the aid of the regulator and the actuator, ensuring that the pedal shows the desired, characteristic behavior.

According to one preferred refinement of the apparatus, it has a force sensor which is coupled to the pedal and can measure the force passed on by the pedal to functional elements coupled to it. In particular, the force sensor can be arranged in the coupling element which connects the actuator to the pedal, with the result that it measures the forces exchanged between the actuator and pedal. In the static case (unmoved pedal), the force measured by the force sensor is proportional to the pedal force exerted on the pedal by the driver; given corresponding lever ratios, said forces even being precisely the same as the pedal force. The force sensor can deliver important information for the feedback regulation of the pedal.

In another development of the apparatus, the latter has an acceleration sensor which is coupled to the pedal and measures the pedal acceleration, i.e. the second derivation of the pedal position over time. It becomes apparent that, in dynamic operations (moved pedal), the pedal acceleration permits forces of inertia of the pedal mechanism to be taken into consideration. Although they are noticeable in the pedal force exerted by the driver, they are not detected by force sensors arranged downstream.

Various possibilities are suitable for realizing the actuator which acts on the pedal. The actuator preferably comprises, as force-generating element, a hydraulic cylinder which is divided by a piston into a working volume and a complementary volume, the latter lying on that side of the piston which lies opposite the working volume. The working volume can optionally be connected to a high-pressure reservoir via a controllable valve, so that a high pressure can be generated in the working volume. In contrast, the complementary volume is coupled to a low-pressure reservoir continuously or just during the phases in which the working volume is coupled to the high-pressure reservoir. Appropriate activation of the valve therefore enables the working volume to be subjected to a high pressure and thereby enables the piston of the hydraulic cylinder to be moved.

According to one development of the above-described actuator, the latter is designed in such a manner that the working volume can optionally be coupled to a low-pressure reservoir via said valve and the complementary volume can be coupled to a high-pressure reservoir. The high-pressure reservoir and the low-pressure reservoir are preferably the reservoirs which have already been mentioned. The possibility of also optionally connecting the complementary volume to a high-pressure reservoir gives rise to a double-action (two-sided) hydraulic cylinder which manages without additional auxiliary means for resetting the piston.

In the configuration of the actuator as a hydraulic cylinder, the working volume and/or the complementary volume can furthermore be connected permanently to a low-pressure reservoir and/or to each other via throttles. A time-delayed pressure equalization can then take place via the throttles.

The throttles can optionally be adjustable, thus enabling the throttling characteristic to be set as required. In particular, the throttling coefficient can then be defined in accordance with the operating point of the simulation system.

The described apparatus can furthermore be supplemented by one or more devices for passively simulating a pedal behavior. Devices of this type exert on the pedal a force which is dependent on the pedal position, the pedal speed and/or the pedal acceleration and which the driver feels as a counterforce to the pedal force. The passive devices can therefore take over a fundamental share of simulating an actuating behavior, the precise coordination in order to generate a special behavior being taken over by the active regulating system which has been explained.

The invention furthermore relates to a method for simulating a predetermined actuating behavior of a pedal (“pedal feel”) by adjusting the pedal position, the pedal position being detected by sensors. The method is defined in that

the pedal force exerted on the pedal by the driver is determined;

a desired positioned of the pedal which is dependent on said pedal force in accordance with the desired actuating behavior of the pedal is determined; and

said desired position of the pedal is set in a feedback regulating loop.

The method can be carried out, in particular, with the aid of the previously explained apparatus and can be varied in accordance with the developments of the apparatus.

According to one preferred development of the method, the pedal acceleration and the force passed on by the pedal are measured, and the pedal force exerted on the pedal by the driver is determined taking these measured values (passed-on force, pedal acceleration) into consideration. By taking the pedal acceleration into consideration, a very precise determination of the pedal force is possible even in dynamic situations, i.e. when the pedal is moved, since the pedal acceleration permits conclusions to be drawn over the mass forces of inertia contained in the pedal force.

### BRIEF DESCRIPTION OF THE DRAWINGS

The invention will be explained in greater detail below by way of example with the aid of the figures, in which:

FIG. 1 shows, schematically, the components of a simulation apparatus according to the invention with a double-action hydraulic cylinder, and

FIG. 2 shows an alternative refinement of the apparatus with a single-action hydraulic cylinder.

### DETAILED DESCRIPTION OF THE PREFERRED EMBODIMENTS

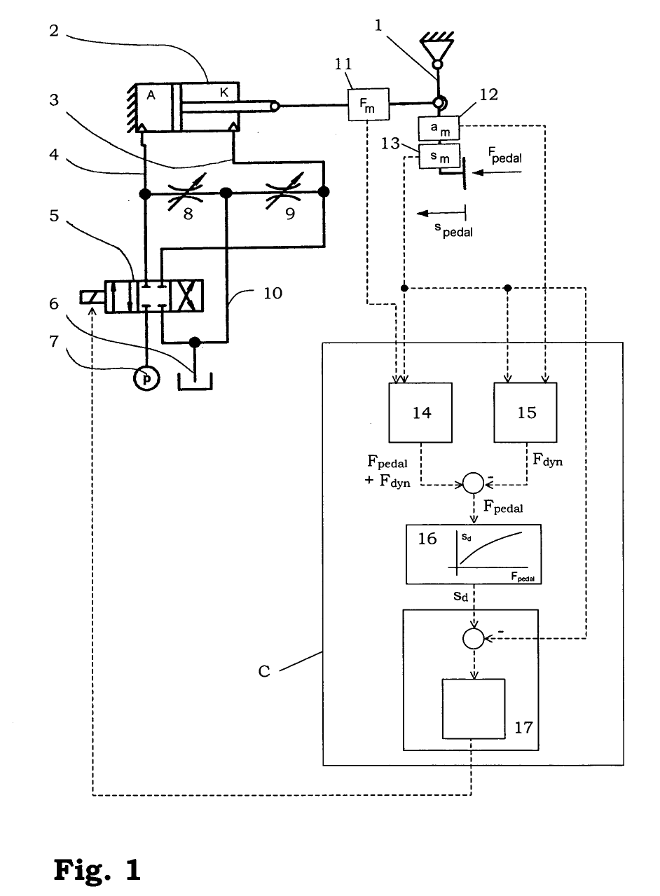

FIG. 1 schematically illustrates a foot pedal 1 which can be, in particular, the brake pedal or the accelerator pedal of a motor vehicle. The pedal 1 is fixed onto a motor vehicle (not shown) in a manner such that it can pivot about an axis and has a pedal plate on which the driver can exert the pedal force F_{pedal}. As a reaction to this action force, the pedal 1 can rotate about the pivot axis and the pedal plate is deflected to the position S_{pedal}. Pedal position S_{pedal} may be defined by linear and/or angular displacement or travel from a reference position.

The pedal feel perceived by the driver during actuation of the pedal 1 is determined by the interrelationship between the variables of pedal position S_{pedal} and pedal force F_{pedal}. Since the controls undertaken by the pedal in modern motor vehicles are sometimes carried out or supported by active units—such as, for example, a brake booster—the active interrelationship, which is present in a purely mechanical pedal, between the pedal force and functional control which is caused is largely lost.

In order again to give the driver the desired, familiar feeling upon actuation of the pedal 1, in the apparatus according to the invention the pedal 1 is coupled to the piston of a hydraulic cylinder 2, so that appropriate activation of the hydraulic cylinder 2 enables a force to be exerted on the pedal 1 and its position to be adjusted. In this case, the hydraulic cylinder 2 is regulated as described below in such a manner that a desired interrelationship between pedal position S_{pedal} and pedal force F_{pedal} arises.

The hydraulic cylinder 2 is divided by the piston into a working volume A and a complementary volume K. The working volume A can be charged with hydraulic medium via a feed line 4 and the complementary volume can be charged via a feed line 3. An electromagnetic servo valve 5 coupled to the feed lines 3, 4 can be activated in this regard in such a manner that

the working volume A is connected to a high-pressure reservoir 7 and the complementary volume K is connected to a low-pressure reservoir 6, or

the working volume A is connected to the low-pressure reservoir 6 and the complementary volume K is connected to the high-pressure reservoir 7, or

the working volume A and complementary volume K are not connected to either of the pressure reservoirs.

Since both the working volume A and the complementary volume K can be subjected (in opposite directions) to high pressure or low pressure, the double-action hydraulic cylinder 2 is involved here.

As can furthermore be seen from FIG. 1, the feed lines 3 and 4 to the complementary volume K and working volume A are connected to the low-pressure reservoir 6 via a respective hydraulic junction point and a respective hydraulic throttle 9 and 8. The throttles 8 and 9 are used with a corresponding time delay to always equalize the pressure in the direction of the lower pressure. The throttles 8 and 9 can preferably be adjusted manually or electrically, it being possible in the last-mentioned case to match the throttling coefficient to the operating point of the simulation of the pedal feel.

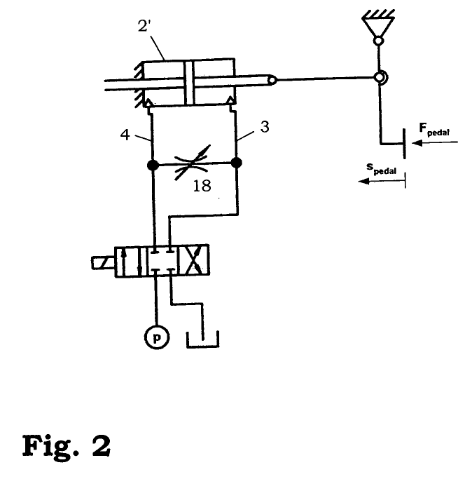

FIG. 2 shows a variant of the apparatus described up to this point, this apparatus operating with a single-action hydraulic cylinder 2′. Furthermore, in contrast to FIG. 1, this variant is provided with just one throttle 18 which connects the feed lines 4 and 3 to the working volume A and complementary volume K to each other. A connection to the low-pressure reservoir is therefore rendered superfluous. As illustrated in FIG. 2, the throttle 18 may be arranged externally but it could also be integrated internally into the piston of the hydraulic cylinder 2′.

Turning back to FIG. 1, the regulation of the hydraulic cylinder 2 which simulates the desired pedal behavior (corresponding details also apply of course to the hydraulic cylinder 2′ of FIG. 2) will now be described. In this regard, reference will be made first of all to a force transducer 11 in the coupling between the pedal 1 and piston of the hydraulic cylinder 2 and to an acceleration sensor 12 and a displacement transducer 13 (position sensor) of the pedal 1. The force Fₘ measured by the force transducer 11, the acceleration aₘ measured by the acceleration sensor 12 and the position sₘ of the pedal which is measured by the displacement transducer 13 are passed in the form of input signals to a controller C. The latter can be realized, for example, with the aid of a microcontroller.

In the controller C, the measured force Fₘ and the pedal position sₘ are processed in a first block 14 in accordance with a first algorithm in order to cancel out therefrom the pedal force F_{pedal} plus a dynamic force component F_{dyn}. The dynamic force component F_{dyn} is brought about by the effects of the mass moment of inertia of the pedal mechanism. In the case of small dynamics, said effects can be ignored, and a good approximation of the pedal force F_{pedal} can be worked back to from the kinematics of the pedal mechanism, calculated from the pedal position sₘ, and the measured force Fₘ. However, this may not be an adequate approximation in the case of high actuating dynamics, since the force of inertia F_{dyn} of the pedal mechanism then significantly increases. F_{dyn} is therefore calculated in a second block 15 from the input variables of the pedal acceleration am and the measured pedal position sₘ. This can be accomplished, for example, with the aid of stored characteristics of the pedal and related components. The determined value of F_{dyn} can then be subtracted from the output of the block 14 in order to determine the sought pedal force F_{pedal}.

In the following block 16 of the controller C, the determined pedal force F_{pedal} is used as an input in order to calculate from it the desired position s_{d} of the pedal 1 in accordance with a desired actuating behavior. In block 16, the pedal characteristics which are desired and, in principle, can be freely predetermined, are therefore implemented as a force/position curve. Accordingly, in the embodiment of the invention depicted in FIG. 1, blocks 14, 15 and 16 comprise a desired position unit that defines a desired position of the pedal corresponding to the pedal force.

The desired position s_{d} then constitutes the guiding variable for an electrohydraulic position control circuit connected downstream. In the associated regulator block 17, the deviation s_{d}—sₘ between the desired position and the measured pedal position is firstly calculated. From this deviation, a suitable actuating variable for activating the servo valve 5 is then calculated in accordance with a regulating algorithm, for example a proportional/integral/differential algorithm, and passed on to servo valve 5. The resulting adjustment of the servo valve 5 causes the hydraulic cylinder 2 to be subjected to pressure in such a manner that it moves the pedal 1, which is coupled to it, in the direction of the desired position s_{d}. The described system constitutes a feedback control circuit causing the actual position of the pedal to track the desired position predetermined by the desired position limit.

The active simulation apparatus which is described can be combined with passive pedal feel simulators. In this case, a passive pedal feel simulator is understood as meaning an apparatus in which a certain pedal feel is realized with exclusively passive elements which are not supplied with any energy from the outside.

The figures accordingly show one example for an electrohydraulic pedal feel simulator according to the invention which can be used in all types of motor vehicle. In this simulator, the pedal angle and/or position is adjusted by an electrohydraulic servo unit which is part of a position control circuit. The guiding variable of the control circuit is the pedal position s_{d} which is calculated from the pedal force F_{pedal} and suitable mathematical algorithms. Since the algorithms can be selected freely in terms of their structure and their parameters, different pedal feels can be produced with the apparatus. The pedal force F_{pedal} is determined by a force transducer 11 which is arranged in the coupling rod between the hydraulic cylinder and pedal, it being possible for interfering dynamic forces to be eliminated computationally by an additional measurement of the pedal acceleration aₘ.

1. An apparatus for simulating a predetermined actuating behavior of a vehicle control pedal, the apparatus comprising an actuator operative to move the pedal and a pedal position sensor, wherein the apparatus further comprises:
a force-determining unit for determining a pedal force applied to the pedal by a driver;
a desired position unit coupled on the input side to the force-determining unit and operative to define a desired position of the pedal corresponding to the pedal force;
a regulator coupled on the input side to the desired position unit and the position sensor and coupled on the output side to the actuator, the regulator using a feedback control loop to activate the actuator to move the pedal toward the desired position.

2. The apparatus as claimed in claim 1, wherein the force-determining unit comprises a force transducer coupled to the pedal and operative to measure the force passed on by the pedal.

3. The apparatus as claimed in claim 1, wherein the force-determining unit comprises an acceleration sensor coupled to the pedal and operative to measure the pedal acceleration.

4. The apparatus as claimed in claim 1, wherein the actuator comprises a hydraulic cylinder with a working volume and a complementary volume, and wherein the working volume is coupled to a high-pressure reservoir via a valve and the complementary volume is coupled to a low-pressure reservoir.

5. The apparatus as claimed in claim 4, wherein the valve is operative to selectively couple the working volume to a low-pressure reservoir, and the valve is further operative to selectively couple the complementary volume to the high-pressure reservoir.

6. The apparatus as claimed in claim 4, further comprising at least one throttle disposed between at least one of the working volume, the complementary volume the low-pressure reservoir, and the high-pressure reservoir.

7. The apparatus as claimed in claim 6, wherein the at least one throttle is adjustable.

8. The apparatus as claimed in claim 1, further comprising at least one device for passively simulating the pedal behavior.

9. A method for simulating a predetermined actuating behavior of a pedal by adjusting the pedal position, the method comprising the steps of:
detecting the pedal position;
determining the pedal force;
determining a desired position of the pedal as a function of at least the pedal force; and
using a feedback regulating loop to set the desired position.

10. The method as claimed in claim 9, wherein the step of determining the pedal force is accomplished by measuring and taking into consideration a pedal acceleration and a force passed on by the pedal.
